(19) United States
(12) Patent Application Publication
(10) Pub. No.: US 2015/0086948 A1
(43) Pub. Date: Mar. 26, 2015

(54) BEHAVIORAL CHANGE MODEL WITH EVIDENCE-BASED, CLINICALLY PROVEN COMMUNICATION SKILLS AND METHODS FOR PROVIDING THE ONLINE EDUCATION OF THE SAME

(71) Applicant: Georgianna Donadio, Wellesley, MA (US)

(72) Inventor: Georgianna Donadio, Wellesley, MA (US)

(21) Appl. No.: 14/494,516

(22) Filed: Sep. 23, 2014

Related U.S. Application Data
(60) Provisional application No. 61/882,591, filed on Sep. 25, 2013.

(51) Int. Cl. G09B 5/00; G09B 19/04; G06Q 50/22

(52) U.S. Cl. CPC G09B 5/00; G06Q 50/22; G09B 19/04
USPC 434/219; 434/236

(57) ABSTRACT

A model of patient/client/individual communication, health information and health behavior counseling can include a specific twelve step, twenty dimensions construct as part of a verbal and non-verbal communication skills set and interview process. The model of the present invention can be delivered to the user via a computer platform, thus saving the user from attending a formal, time-specific classroom setting. The computer platform can be, for example, an online platform. The online platform can include printable course materials, recorded classroom presentations, webinars, and the like. An exemplary embodiment provides a method of communication by health care professionals with patients that may be based in neurological, psychological and biochemically predictive responses to behavior change prompts.

### CROSS-REFERENCE TO RELATED APPLICATION

This application claims the benefit of priority of U.S. provisional application No. 61/882,591, filed Sep. 25, 2013, the contents of each are herein incorporated by reference.

### BACKGROUND OF THE INVENTION

The present invention relates to healthcare provider directed patient communication and health behavioral change models and, more particularly, to a model of communication and health behavior intervention that has specific evidence-based research demonstrating proven, easy to learn steps that create successful communication outcomes in both non-computer supported environments and in communications with the use of Health Information Technologies. The present invention relates to an online system for the distribution of learner communication-skills training in utilizing a health behavioral change model to educate healthcare and related professionals.

Currently, non-compliance and patient dissatisfaction are two of the most pervasive issues facing medical practice and health care providers in delivering successful healthcare services. The top ten (10) patient complaints have been ongoing and most recently data confirmed (2013) to be (1) the absence of listening and respectful communication with their doctors and providers, and (2) the lack of demystified health information. In addition to poor communication skills in the healthcare field, health professionals often bring their own personal values or agendas, prejudices and expertise to relationships with their patients. This can create resistance by some patients to directives pertaining to their health care and can also lead to issues with compliance and self-care.

With the Centers for Medicare and Medicaid Services (CMS) Meaningful Use mandated in law, the use of certified Electronic Health Record (EHR) technology for eligible professionals and hospitals, is further deteriorating satisfaction in the provider-patient relationship and requires a successful intervention that can be easily, inexpensively and quickly disseminated to health professionals through professional continuing education.

The patient-provider relationship is an essential element of quality medical care with empathy as a core component. Patients want to be valued, seen, and heard. Further, effective communication among providers enhances the quality of working relationships, job satisfaction and has a profound effect on patient safety. Research reveals a direct correlation between provider satisfaction and patient satisfaction, with communication being one of the major drivers in satisfaction among healthcare providers.

The use of the internet to convey health-related information to consumers has grown over the past decade. Internet-based behavior management models permit a large number of individuals to be reached at fairly low costs. These approaches assess individual need based on traditional theory by pairing the individual's stage of change to resources on the internet. Research shows the effectiveness of internet-based interventions is enhanced by the use of additional methods of communicating with individuals.

As traditional, provider-focused practices shift to patient-centered care using Health Information Technologies (HIT), providers must develop communication skills that empower patients by seeing health from the patient's perspective and motivating and educating patients in health-related self-management.

Efforts to contain costs and increase productivity have placed even greater time constraints on face-to-face patient-provider communications as providers attempt to care for increasingly chronically ill patients. HIT offer opportunities to enhance patient-provider partnerships by empowering patients to self-manage more effectively and facilitate and reinforce health behavior changes. Provider usage of Electronic Health Records (EHRs) may assist in completing information intensive tasks; however, research reveals they are less likely to explore psychosocial/emotional issues such as how health status affects a patient's life. While HIT are geared toward enhancing patient-provider encounters, research indicates the EHR may detract from interpersonal connection hindering communication in the patient-provider relationship.

The interference with face-to-face patient care is among the principal sources of provider dissatisfaction with the concern of compromising patient care for adhering to the mandates of EHR documentation.

HI technologies are often not readily accessible to subgroups of the patient population (e.g., the elderly or underserved populations). Disparities in access and usage are evident in disadvantaged groups. While individuals with chronic illnesses are less likely to have Internet access than healthier adults, 62% as opposed to 81%, respectively, those with chronic illnesses have a higher likelihood to utilize HIT and are likely to benefit even more.

Improving patient adherence and outcomes through healthier lifestyles will require a deeper understanding of how to effectively engage patients through the patient-provider relationship. Many behavioral interventions have been inconsistently defined and have shown mixed results. Further, the degree of behavioral change and communication-skills training reported is lacking.

Various behavioral health interventions have shown initial enhancement to behavioral change; however, they do not identify tools that produce sustainable change. Additionally, electronic theoretical models developed to enhance engagement are introducing a dehumanizing factor in the patient-provider relationship. Extensive literary review on the effectiveness of strategies to improve patient-provider communication shows little is known about the degree to which positive short-term effects are demonstrated over time. Further, limited research has been published on the direct impact of EHRs on provider-patient relationships or how EHRs improve or hinder communication.

Given the plethora of research linking ineffective provider-patient communication with increased non-adherence, poor health outcomes, and patient and provider dissatisfaction, it is imperative communication skills deficits are addressed in the patient-provider encounter. A behavioral change model that is whole person focused and applies an integrated approach to interpersonal communication, engaging both patients and providers, is essential to facilitating emotional shifting for sustained behavior change.

Classroom settings are often established in attempts to improve a person's personal and professional communication skills. However, these settings require the person to dedicate a specific time to attend the formal setting. Online education programs have been developed to address these issues. Importantly, there is a lack of education programs addressing a complete behavioral engagement model.

As copious research data has demonstrated, there is a need for a method for improving or transforming communication and relationship outcomes that can be delivered via an online education program to the user. These programs need to fit the scheduling and internet access convenience of the learners. The educational programming and delivery of the present invention provides 24/7 internet access thereto, from anywhere in the world without additional software required.

The present invention serves to address the aforementioned. In summary its benefits overcome barriers imposed by insurer mandates and HIT while responding to industry movements in patient-centered care, whole-person care, and evidenced-based health education for prevention and disease management.

### SUMMARY OF THE INVENTION

One aspect of the present invention, a computer-implemented method for improving communication and affecting behavior change, is comprised of a first learning module which describes for the learner how to engage in predetermined, neurologically specific eye contact and body language (non-verbal communication) with an individual. Nonverbal communication or visual cues can be demonstrated through body positioning, posture, and gaze. A second learning module describing how to engage in predetermined, physically specific posture and body movement with the patient using verbal communication. Verbal communication extends beyond the spoken word to verbal inflection such as pauses in speech and tone of voice. These modules when applied through a 12 step process comprising 20 principals defined collectively evoke a biochemical, neurological, psychological brain response in the individual that allows that individual to access mid-brain (unconscious) or sub-textual feelings with conscious cognitive knowledge and awareness, which invites a positive change in the person's self-awareness and personal behavior as a result of by-passing the individual's stress response and their potential fear and resistance to change.

Each learning module, of which there are five (5), presents various aspects of the model including the 12 steps and the 20 principals designed and develop to achieve the desired provider-patient communication relationship.

Another aspect of the present invention, a computer-based learning system comprises an authentication sub-system allowing a user to register for a learning program that records and displays all access and utilization logs of that learner; and serves as a module delivery sub-system for delivering content from the database to a user that confirms the learner's participation.

These and other features, aspects and advantages of the present invention will become better understood with reference to the following drawings, description and claims.

### BRIEF DESCRIPTION OF THE DRAWINGS

FIG. 1 is a schematic representation of a learning system according to an exemplary embodiment of the present invention; and

FIG. 2 is a schematic representation of a computer server adapted to deliver learning modules to users, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a model of patient/client/individual communication, health information and health behavior counseling that can include a specific twelve step, twenty dimensions construct as part of a verbal and non-verbal communication skills and interview process. The model of the present invention can be delivered to the user via a computer platform, thus saving the user from attending a formal, time-specific classroom setting at a greatly reduced cost. The computer platform can be, for example, an online platform. The Behavioral Engagement with Pure Presence™ online platform does include printable course handouts and research provided materials, recorded classroom presentations, webinars, and the like.

An exemplary embodiment of the present invention can provide a method of communication by health care professionals with patients that may be based in neurological, psychological and biochemically predictive responses to behavior change prompts. There may be neurologically specific eye contact that may be enhanced by physically specific posture and body movement by the professional/facilitator towards the patient. The response evoked by such specific eye contact and body movement is then potentially enhanced by the patient's biochemical brain response to the “pure presence” of the professional. This enhancement may allow the patient to access mid-brain information and consciously integrated sub-textual feelings with cognitive knowledge and awareness. The verbal communication model of the present invention may invite positive change through by-passing a patient's fear and resistance to change and producing “emotional shifting” within the patient, which produces a new worldview, beliefs and values relating to their health behaviors.

The model of the present invention can employ eye contact protocols, body language protocols (and other nonverbal communication protocols), verbal communication protocols, intentionality protocols, and agenda protocols. These elements must be integrated into the model such that, if the health care professional does not specifically follow the steps as they are intended to be followed, the model may not produce the same measurable and favorable outcomes as when the steps are followed. This specific step component of the model has been developed, tested and proven over a 35 year period of research in Boston area and nation hospitals and medical centers. This Behavioral Engagement with Pure Presence™ process may result in better patient compliance with health care directives and can significantly reduce costs for insurance companies, hospitals, and medical care and government programs. No other patient behavior model is known to have the science-based, neurological and biochemical research as its theoretical construct.

Specific elements of the model may include utilizing the following which embody the 20 principals: Pure Presence (a state of being fully and wholly present to another person); centered sitting posture (a specific posture used for specific scientific reasons); specific eye contact science and application protocol; specific non-obstructive body language with specific verbal and non-verbal communication skills and protocol; engagement of both the professional and the patient's intentionality (which may require the professional to do specific preparation work before engaging with the patient and to follow specific “clearing” protocol after working with the patient before moving on to the next client/patient); a recognition of a specific emotional behavior that honors the sacredness of the patient-professional relationship; evocative silence in the space between words (a specific, prescribed amount of time may be created between verbal communications); whole person centering techniques for the professional, who may be instructed to use specific centering techniques should she/he begin to lose focus or be emotionally provoked or stimulated by the patient; and, a technique termed “no trace camping” to reduce derailing the patient's emotional shifting (emotional shifting is facilitated by a neurological process that integrates limbic, alpha wave brain function and beliefs or worldview with new cortical, beta wave brain function cognitive information).

While the above example refers to patient/caregiver relationships, the methods of the present invention can be applied to any personal or professional relationship.

The model of the present invention may be taught via a computerized learning system. The system can be, for example, an online system, where users access the system via an internet connection. The user enters a specific internet address and be taken to a site. Various components of the model may be taught in sections, where access can be provided to each section via a control mechanism, such as requiring password entry, or requiring a user to complete a prior section before moving onto a new section.

Each component of the online system may be stored in a memory or database portion of the system. The components can include slideshow presentations, pre-recorded classroom settings, webinars, and the like. The components can combine to provide aspects of the model to the user of the system.

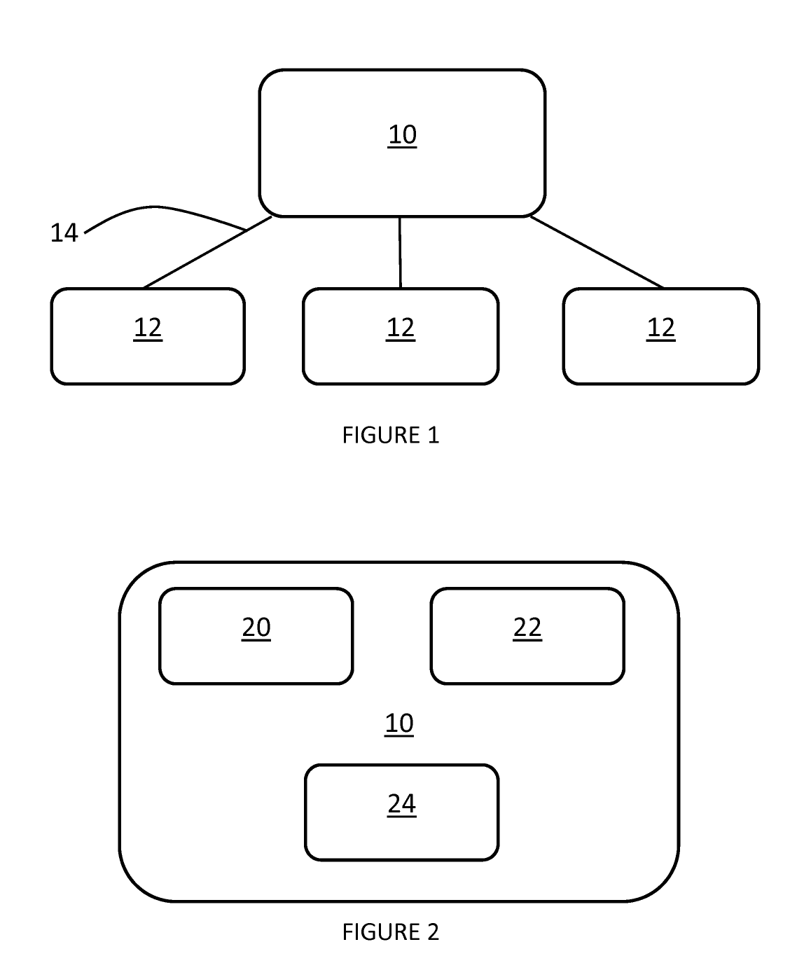

Referring to FIGS. 1 and 2, a computer server 10 can exchange data with one or more client computers 12. The exchange can occur via various methods, such as via an internet connection 14 between the computer server 10 and the client computers 12. Other modes of information exchange can be used in place of an internet connection, such as phone, native application, and the like. The computer server 10 can include an authentication sub-system 20, a module delivery sub-system 22 and a module database 24. The authentication sub-system 20 can receive user information and grant them access to one or more learning modules stored in the module database 24. The module delivery sub-system 22 can be used to deliver the learning module to the user's client computer 12. In some embodiments, the module database 24 may be stored in a cloud computing environment, wherein the module delivery sub-system 22 can prompt the module database to deliver a learning module to the client computer 12 via a cloud-to-computer server data connection.

In some embodiments, the methods of the present invention can include twelve steps. These steps are outlined below. The various modules delivered by the computer server 10 can cover one or more of the steps outlined below.

Step One. Centering—One begins by clearing out any stress or distraction that they might be experiencing, and focus on the opportunity to have a communication with another person that will result in a positive outcome for both individuals. If someone has had prior conflicts with this person, they visualize placing the conflicts aside, along with their own ego needs.

Enter into the communication in a centered, receptive, respectful, mindful, nonjudgmental, fully present, compassionate state; be present to the other person as an equal, and have the desire to maintain this state with the other person throughout the entire communication.

Step Two. It is important to be physically comfortable and relaxed. This will allow an individual to avoid becoming distracted. If you have a comfortable chair that you like to use, be sure it has a back that will allow you to sit upright. We use a centered body language posture to communicate and support our centered, respectful, mindful presence to the other person.

This will relax the professional/learner as well as the other person, and assist in remaining in Pure Presence throughout the communication. Identify any physical distraction that might cause the loss of attention, focus, or center. Before beginning the exchange with the individual, remove any distraction, such as a ticking clock, or turn the ringer of the phone off.

Fidgeting, looking away, answering a cell phone, or focusing any physical attention on self will be distracting to the other person and will communicate to them that you are not fully present in the conversation.

It is best not to schedule any other activity near or around the same time as the conversation, as the encroachment of outside distraction can derail efforts to have a focused, centered conversation.

Step Three. After securing the centered body language posture, eye contact with the other person is the next step to facilitating Pure Presence in your communication. Eye contact is soft and soothing, never aggressive or probing. The way we look at the other person communicates our inner dialogue. Awareness of this and remaining centered in thought and intention is critical. Eye contact can create a physical response in the other person that elevates trust, comfort, and safety. These are ideal states with intimate relationships, especially those we wish to enhance and deepen. This eye contact connection has demonstrated, in several studies, to evoke trust and receptiveness and allow for emotional shifting which leads to behavior change.

Step Four. Check your intention. Throughout the communication, keeping the intention open, centered, and nonjudgmental is an important part of creating the desired state of Pure Presence with the other person. If we begin to feel an emotional trigger, or an ego need surfacing, we can mentally repeat the word intention to help become centered again.

Conversations with our intimate relationships can go off track because we lose our focus and then the opportunist “pop-ups”—just like on the computer—find their way into our thinking. Just as there are “pop-up” blockers on the computer, checking our intention will allow us to avoid being drawn away from our center and able to remain purely present. Distractions, both internal and external, can derail our communications. If the communication begins to go off track, we can immediately check if there is a personal agenda that may be unconsciously coming up. Example: Wanting an apology or wanting to “be right.”

Step Five. Respectful Inquiry—If we have asked to have this conversation with the other person, we might begin the exchange with respectful inquiry, asking them their feelings about the matter that we wish to clarify. For example: “Sweetheart, could you share or clarify the way you were feeling when we argued about going to your aunt's house for the holidays?” Once we ask this question, we do NOT continue speaking, but allow the other person the opportunity to gather their thoughts and respond.

Our intention and eye contact will signal to them that we are sincerely interested in hearing how they feel and what they have to say. If we keep talking, or interrupt them, the conversation will become about our feelings and not the other person's. If we begin to feel anxious, re-center the intention and check your centered body language posture, so that we are back in Pure Presence and avoiding the pitfalls of emotional triggering.

Step Six. Be responsive without interjecting. Do not probe, ask questions, or interrupt. Our eyes, facial muscles, smile, nodding, eyebrow movements, and short responses, such as “Thanks,” “Really?”, “Aha,” and so forth, will allow the other person to process into the beta-alpha overlap and go on to self-discernment. With the practice of Behavioral Engagement (BE) we will come to understand why many conversations self-destruct, and why we become easily distracted. It is when we enter back into our ego state, or become self-focused, that we derail the communication, and this leaves both parties feeling unheard and not valued.

Step Seven. Respect and welcome the silence between the verbal communications. In this special time of stillness, we can catch a glimpse of our subconscious triggers and gain awareness of how and why we may choose to transform them. This can alter a belief, or worldview, we hold in our thinking brain, and allow for emotional shifting and behavior re-direction to take place.

Step Eight. Be patient—with yourself and the other person—during the Behavioral Engagement process. The health professionals who use BE spend upward to an hour with each person they interview. It takes an unfolding of the other person's conversational comfort level, as well as trust in the intention of the exchange, for them to experience the expansiveness that Behavioral Engagement provides. Many of us are not used to being treated with such respect and integrity, or experiencing such freedom to express our true thoughts and feelings

It can take time for people to realize we do not have an agenda, or want a particular outcome from the exchange with them, and that we are not going to judge them or give advice or suggestions. Let's face it, many times we do.

Step Nine. Your intention will become your agenda, so be honest with yourself about what your motive is for entering into the conversation. As we apply BE in your work and life, we will become more centered and less self-serving in relationships. This Pure Presence intention will perfect the BE skills to strengthen and uplift all relationships and communications.

Step Ten. “I” statements—At some point in the conversation we will verbally respond to the other person, and it is important that we use “I” statements to express our feelings. Using “I” statements shows that these are our feelings and not a statement about what occurred in a previous situation or discussion. To keep the emotional triggers, or charge, out of the conversation, we must own what we feel. We should not try to prove what we feel as the truth. In this appropriate way we show respect for the other person's experience, which is essential in the BE process.

Step Eleven. Allow for discovery. One of the transformational components of BE is that if we remain true to the model and stay in our Pure Presence center, we will make discoveries that will shift us emotionally. These emotional shifts will bring about behavioral change in us, as well as reciprocal changes in the other person in the relationship. As we have learned, many behaviors are rooted in feelings and beliefs. When they shift, our behaviors can shift, and then we have sustainable, authentic behavioral change that can have positive long-term results in our lives and with our relationships.

Step Twelve. Keep trying, and do not give up on the BE skills development. Once we are exposed to BE, and experience the transformational power it has for ourselves and our relationships, we will want to perfect it. Even if there are some frustrating experiences, we lose your center, and mind wander during a conversation, we can start over again with the next conversation. The important thing is committing to improve the quality of communication in our relationships. In a short period of time we will become quite skilled as we experience a new level of success and fulfillment in all of our relationships!

### Pilot Studies

The first pilot studies on the model incorporated the following: disease prevention through demystified health information, respectful peer presence, shared decision making and whole health advocacy for patient wellness and self-directed care. The model was shown to consistently re-moralize and spark renewed interest in health and well-being in medically-challenged patient populations studied. Subsequent findings reported the relationship of provider with patient gave people a behavior model that, with the content of the education, allowed for persistent lifestyle changes concluding this method of education could help transform medical care for patients and providers.

The goal of this research was to demonstrate how this behavioral change model created better communication outcomes in healthcare benefiting both patients and providers. It also created an evidence-based way to bring the model into a variety of healthcare delivery environments. The model has shown consistent, effective communication skills results in enhanced patient-provider relationships, ability to overcome communication behaviors in the healthcare environment, sustained patient behavior change, improved patient adherence to treatment regimens and therefore patient outcomes, increased patient-provider satisfaction, and increased efficiency and cost management of health care organizations.

### Clinical Trial Study

### Titled

Utilization of Behavioral Engagement with Pure Presence™ in Electronic Health Record Communications: Effects on Patient-Provider Relationships in Chronic Disease Management

### Summary

The purpose of this randomized controlled clinical trial study is to explore the effects of Behavioral Engagement with Pure Presence™ in patient-provider relationships on patients with chronic illnesses while utilizing the model in Electronic Health Record (EHR) communications. The behavioral change model of the present invention, as applied in the clinical trial, applies an integrated approach to inter-person communication while engaging both patients and providers, facilitating emotional shifting which is essential to sustained behavior change.

Patients 21 through 80 years of age meeting eligibility criteria will be recruited through practice sites to be determined. Providers (i.e., physicians, physician assistants, nurse practitioners, and registered nurses) will be trained to implement the model through a computer-based, online platform, as described above, comprising the Behavioral Engagement and Pure Presence™ training program.

Data analysis will compare the means of the patient study group at baseline, 90 days and at six months post-implementation of the model to examine the effects of the intervention on physiological and psychological factors. A pre- and post-intervention evaluation will be administered to trained providers to measure workplace satisfaction. Implications include increased patient-provider satisfaction, improved patient outcomes, and sustained patient behavior change.

Results of the clinical trial will attempt to determine the effects of Behavioral Engagement with Pure Presence™ on 1) the patient-provider relationship in patients with chronic illnesses for chronic disease management and 2) for communication-skills training of providers to improve the patient-provider encounter for implementation in outpatient protocol.

### Methodology

The research will collect quantitative and qualitative survey data of provider and patient participants measuring their perspective of communication and the patient-provider relationship. The surveys will compare the perspectives of patients and providers pre- and post-intervention. As the Behavioral Engagement with Pure Presence™ Model was formulated to provide communication-skills training for providers, the knowledge gained from this research may demonstrate the significance of its application in outpatient protocol to improve the patient-provider encounter.

### Anticipated Results

Patients 21 through 80 years of age diagnosed with one or more chronic illnesses who participate in Behavioral Engagement with Pure Presence™ will experience improved physiological effects, as indicated by SF-12v2 (i.e., physical component summary measures) and clinical assessments (i.e., adherence to medication, diet, provider recommendations, etc).

Patients 21 through 80 years of age with one or more chronic illnesses who participate in Behavioral Engagement with Pure Presence™ will experience improved psychological effects, as indicated by SF-12v2 (i.e., mental component summary measures) and the Assessment of Care and Provider Empathy in HER Usage to include semi-structured interview.

Healthcare providers who practice Behavioral Engagement with Pure Presence™ in patients 21 through 80 years of age diagnosed with one or more chronic illnesses will experience enhanced patient-provider satisfaction, an increase in self-directed patient-provider compliance, and enhanced job satisfaction, as indicated by the Work Satisfaction Survey.

The clinical trial will help determine the physiological effects, if any, of introducing Behavioral Engagement with Pure Presence™ in patient-provider relationships on patients with chronic illnesses. Moreover, the clinical trial will help determine the psychological effects, if any, of introducing Behavioral Engagement with Pure Presence™ in patient-provider relationships on patients with chronic illnesses.

It should be understood, of course, that the foregoing relates to exemplary embodiments of the invention and that modifications may be made without departing from the spirit and scope of the invention as set forth in the following claims.

What is claimed is:

1. A computer-implemented method for improving communication and affecting behavior change, the method comprising:
displaying a first learning module to a user, the first learning module describing how to engage in predetermined, neurologically specific non-verbal communication with a person; and
displaying a second learning module to a user, the second learning module describing how to engage in predetermined, physically specific posture and body movement toward the person using verbal communication, wherein
the eye contact, posture and body movement toward the person evokes a biochemical brain response in the person that allows the person to access mid-brain information and consciously integrated sub-textual feelings with cognitive knowledge and awareness while inviting a positive change in the person through by-passing the person's stress response and their potential fear and resistance to change.

2. The method of claim 1, wherein the verbal communication includes spoken word, verbal inflection, pauses in speech and tone of voice.

3. The method of claim 1, wherein the non-verbal communication includes at least one of eye contact and body language.

4. The method of claim 3, wherein the non-verbal communication includes at least one of body positioning, posture, and gaze.

5. The method of claim 1, wherein the user is a physician or direct healthcare provider and the person is a patient.

6. The method of claim 1, wherein the learning modules include at least one of a slideshow, a webinar, and a pre-recorded classroom presentation.

7. The method of claim 1, further comprising completing each of the first learning module, the second learning module and additional learning modules in order.

8. The method of claim 7, further comprising a testing sequence delivered after completion of each of the learning modules.

9. A computer-based learning system comprising:
an authentication sub-system allowing a user to register for a learning program;
a database containing at least a first learning module and a second learning module, wherein the first learning module describes how to engage in predetermined, neurologically specific non-verbal communication with a person, and the second learning module describes how to engage in predetermined, physically specific posture and body movement towards the person using verbal communication; and
a module delivery sub-system for delivering content from the database to a user.

10. The computer-based learning system of claim 9, wherein the verbal communication includes spoken word, verbal inflection, pauses in speech and tone of voice.

11. The computer-based learning system of claim 9, wherein the non-verbal communication includes at least one of eye contact and body language.

12. The computer-based learning system of claim 11, wherein the non-verbal communication includes at least one of body positioning, posture, and gaze.

13. The computer-based learning system of claim 9, wherein the content from the database is delivered via an internet connection.

14. The computer-based learning system of claim 9, wherein the learning modules include at least one of a slideshow, a webinar, and a pre-recorded classroom presentation.

15. A computer-based, online platform for delivery of a highly interactive training and information for health care providers, comprising:
an authentication sub-system allowing a user to register for a learning program;
a database containing at least a first learning module and a second learning module, wherein the first learning module describes how to engage in predetermined, neurologically specific non-verbal communication with a person, and the second learning module describes how to engage in predetermined, physically specific posture and body movement towards the person using verbal communication; and
a module delivery sub-system for delivering content from the database to a user.

16. The computer-based, online platform of claim 15, wherein the learning program includes a multi-media presentation of material.

17. The computer-based, online platform of claim 16, wherein the multi-media presentation includes at least one of a video presentation, an audio presentation, printed materials, and pre-recorded classroom presentations.

18. The computer-based, online platform of claim 15, wherein the content from the database is delivered via an internet connection.
